(19) United States
(12) Patent Application Publication
(10) Pub. No.: US 2020/0090249 A1
(43) Pub. Date: Mar. 19, 2020

(54) LOCATION BASED VENUE RECOMMENDATION

(71) Applicant: Dara Weislo, Tinton Falls, NJ (US)

(72) Inventor: Dara Weislo, Tinton Falls, NJ (US)

(21) Appl. No.: 16/575,754

(22) Filed: Sep. 19, 2019

Related U.S. Application Data
(60) Provisional application No. 62/733,171, filed on Sep. 19, 2018.

(51) Int. Cl. G06Q 30/06; H04W 4/02; G06Q 50/12; G06Q 50/00

(52) U.S. Cl. CPC G06Q 30/0631; G06Q 30/0623; G06Q 50/01; H04W 4/025; G06Q 50/12; G06Q 30/0639

(57) ABSTRACT

A location based venue recommendation is described. A selection of a location (such as a current or destination location) provided by a user is captured. A selection of a category (such as a restaurant, a café, a bar, a market, a bakery, a park, or a retail store) provided by a user is also captured. An attribute (such as a need or a preference) of the user is also determined. A venue information provider is queried with the selected location and category and the attribute of the user. A venue recommendation is received from the venue information provider. A venue associated with the venue recommendation is in a proximity to the selected location, is within the selected category, and a feature of the venue accommodates the attribute of the user. Furthermore, the venue recommendation is displayed to the user.

### CLAIM OF PRIORITY

This application claims priority to U.S. Application 62/733,171 filed on Sep. 19, 2018, the contents of which are herein fully incorporated by reference in its entirety.

### FIELD OF THE EMBODIMENTS

The field of the embodiments relate to a system to provide a location based venue recommendation. The location based venue recommendation is designed to include information on a venue that provides a feature accommodating an attribute of a user.

### BACKGROUND OF THE EMBODIMENTS

Information exchange have changed processes associated work and personal environments. Automation and improvements in processes have expanded scope of capabilities offered for personal and business data consumption. With the development of faster and smaller electronics, a variety of mobile devices have integrated into daily lives. A modern mobile device include components to provide variety of services such as communication, display, imaging, voice, and/or data capture, among others. Abilities of the modern mobile device jump exponentially when networked to other resources that provide a previously unimagined number of services.

A social network is service that is enabled by modern advances in technology. The social network provides a capture, analysis, classification, and presentation of information associated with individuals that make up members of the social network. The personal information of the members is integrated and presented as the social network service. The social network also includes information associated with one or more venue(s) that are utilized by the members. Information associated with the venue can be integrated with the social network in a variety of ways. Below are some examples of social networking systems that integrate venue information.

U.S. Pat. No. 9,319,470 pertains to a system for receiving and distributing social media content associates content with a particular geographic location.

U.S. Pub. 20110137997A1 pertains to systems, methods, apparatus and software that have been discovered for use by individual users to monitor the geographic location of other people or assets with some relationship to the user.

U.S. Pat. No. 8,554,875 pertains to methods, systems, and apparatuses which include receiving, from a user operating a user interface on a computing device, an indication of a first future date; identifying one or more friends of the user, for each of the one or more friends, gathering future trip information from the social network, determining based on the gathered trip information, whether each of the one or more friends are going to be physically present at the future locations on one of the second future dates that matches the first future date, displaying a geographic map on the user interface including displaying a friend representation corresponding to each of the respective future locations where one or more friends are going to be physically present on the first future date, and dynamically updating the friend representations respectively on the geographic map based on a third future date received.

Chinese Pat. 101044504 pertains to systems and methods for social networking. Location-related data and other behavioral and exogenously generated characteristics are used to replace or supplement self-generated profiles in order to enhance the quality and trustworthiness of the matches made using the system and facilitate the inputting of profile information.

U.S. Pat. No. 9,119,027 pertains to a method and/or system that allows a user of a social networking service to publish a content item tagged with location information for sharing with other users of the social networking service.

U.S. Pub. 20120233238A1 pertains to a geo-social networking system records location data of a user, generate a set of recommendations based on the user's location data, and present one or more recommendations of the set of recommendations to the user based on the user's current location.

None of the art described above addresses all of the issues that the present invention does.

### SUMMARY OF THE EMBODIMENTS

The present invention and its embodiments relate to a location based venue recommendation. A system may provide the location based venue recommendation. The system may include a venue server. The venue server may be configured to provide the venue recommendation. A mobile device may also be configured to receive an initial input from a user. The initial input may include a selected location. A subsequent input may also be received from the user. The subsequent input may include a selected category. In addition, an attribute of the user may be determined. Next, the venue server be queried with the selected location, the selected category, and the attribute of the user. In response, the venue recommendation may be received from the venue server. In an example scenario, a venue associated with the venue recommendation may be in proximity to the selected location, may be within the selected category, and a feature of the venue may accommodate the attribute of the user. Furthermore, the venue recommendation may be displayed to the user.

In another embodiment of the present invention, a mobile device for providing a location based venue recommendation is described. The mobile device may include a display component configured to accept an input and display an output associated with a social networking application. A camera component may be configured to capture a picture in relation to the social networking application. A location component may be configured to determine a current location in an association with the social networking application. A memory may be configured to store instructions associated with the social networking application. A processor may be coupled to the display component, the location provider, the camera component, and the memory. The processor may execute the instructions associated with the social networking application. The social networking application may include a recommendation engine. The recommendation engine may be configured to receive a current location from the location component. Furthermore, a selected category provided by a user may be received as an input on the display component. In addition, an attribute of the user may be queried and received from an external user information provider. Next, the venue recommendation may be queried and received from a venue provider. A venue associated with the venue recommendation may be in a proximity to the current location, may be within the selected category, and a feature of the venue may accommodate the attribute of the user. Furthermore, the venue recommendation may be provided to the display component for a presentation to the user.

In yet another embodiment of the present invention, a method of providing a location based venue recommendation is described. The method may include receiving a destination location provided by a user. Furthermore, a selected category provided by the user may also be received. In addition, an attribute of the user may be queried and received from an external user information provider. Next, a venue recommendation may be queried and received from a venue provider. A venue associated with the venue recommendation may be in a proximity to the destination location, may be within the selected category, and a feature of the venue may accommodate the attribute of the user. Furthermore, the venue recommendation may be displayed to the user. The proximity of the destination location may include a surrounding area centered around the destination location.

It is an object of the embodiments of the present invention to provide a location based venue recommendation.

It is an object of the embodiments of the present invention to locate a venue that provides a feature that accommodates an attribute of the user.

It is an object of the embodiments of the present invention to provide a venue recommendation of a venue within a surrounding area centered on a current location or a destination location of the user.

It is an object of the embodiments of the present invention to provide controls to evaluate and confirm the feature provided by the venue.

These and other features, aspects and advantages of the present invention will become better understood with reference to the following drawings, description and claims.

### BRIEF DESCRIPTION OF THE DRAWINGS

FIG. 1 shows a conceptual diagram illustrating examples of providing a location based venue recommendation, according to an embodiment of the invention.

FIG. 2 shows a display diagram illustrating interactions between components of a system that provides a location based venue recommendation, according to an embodiment of the invention.

FIG. 3 shows a display diagram illustrating a mechanism of providing a location based venue recommendation, according to an embodiment of the invention.

FIG. 4 shows a display diagram illustrating an example of a user experience providing a location based venue recommendation, according to an embodiment of the invention.

FIG. 5 is a block diagram of an example computing device, which may be used to provide a location based venue recommendation.

FIG. 6 is a logic flow diagram illustrating a process for providing a location based venue recommendation, according to an embodiment of the invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations may be made thereto.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing a location based venue recommendation. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

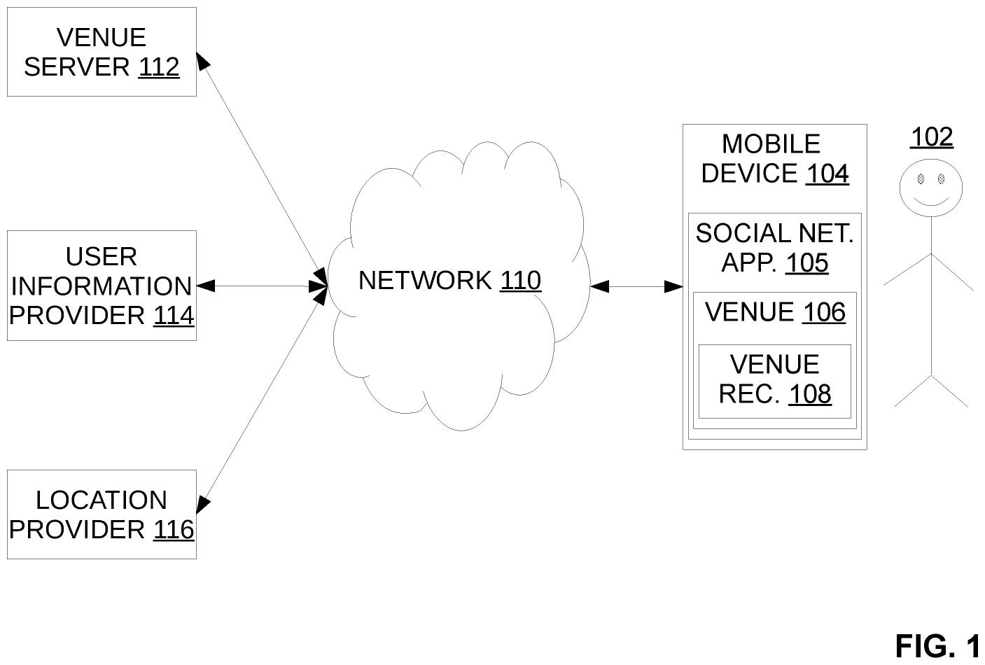

FIG. 1 shows a conceptual diagram illustrating examples of providing a location based venue recommendation. In an example scenario, a mobile device 104 may execute (or provide) a social networking application 105. The mobile device 104 may include a physical computing device hosting and/or providing features associated with a client application. The mobile device 104 may include and/or is part of a smart phone, a tablet based device, and/or a laptop computer, among others. The mobile device 104 may also be a node of a network 110. The network 110 may also include nodes such as a venue server 112, a user information provider 114, a location provider 116, and/or an image recognition provider, among others. The network 110 may connect nodes with wired and wireless infrastructure.

The mobile device 104 may execute a client application such as the social networking application 105. The social networking application 105 may provide features and services associated with a social network to a user 102. The user 102 may be a member of the social network. In an example scenario, the social networking application 105 may receive an initial input from the user 102. The initial input may include a selected location (such as a current location or a destination location). The location provider 116 may generate location options from which the user 102 may choose the selected location. Alternatively, the location options may be generated by components local to the mobile device 104.

The social networking application 105 may also provide categories to the user 102 from which the user may choose a selected category (such as a restaurant and/or a retail store, among others). In an example scenario, the social networking application 105 may receive a subsequent input from the user 102. The subsequent input may include the selected category.

The social networking application 105 may also determine an attribute (such as a specific need and/or a preference, among others) of the user 102. To determine the attribute, the social networking application 105 may query the user information provider 114 with identifying information associated with the user 102. The user information provider 114 may store a profile associated with the user 102 that includes personal information. The user information provider 114 may provide the attribute of the user 102 in response to the query.

The social networking application 105 may next query the venue server 112 with parameters such as the selected location, the selected category, and the attribute of the user 102. The venue server 112 may host and manage information associated with venues. The venue server 112 may receive the parameters and determine a venue recommendation 108 matching the parameters. The social networking application 105 may receive the venue recommendation 108 from the venue server 112. The venue recommendation 108 may provide information associated with a venue 106 that matches the parameters used in the query. Furthermore, the social networking application 105 may display the venue recommendation 108 to the user 102.

Previous example(s) to provide the location based venue recommendation are not provided in a limiting sense. Alternatively, the social networking application 105 may perform operations associated with providing the venue recommendation as a desktop application, a workstation application, and/or a server application, among others. The social networking application 105 may also be a client interface of a server based application.

The user 102 may interact with the social networking application 105 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the mobile device 104, the social networking application 105, embodiments are not limited to these components or system configurations and can be implemented with other system configuration employing fewer or additional components.

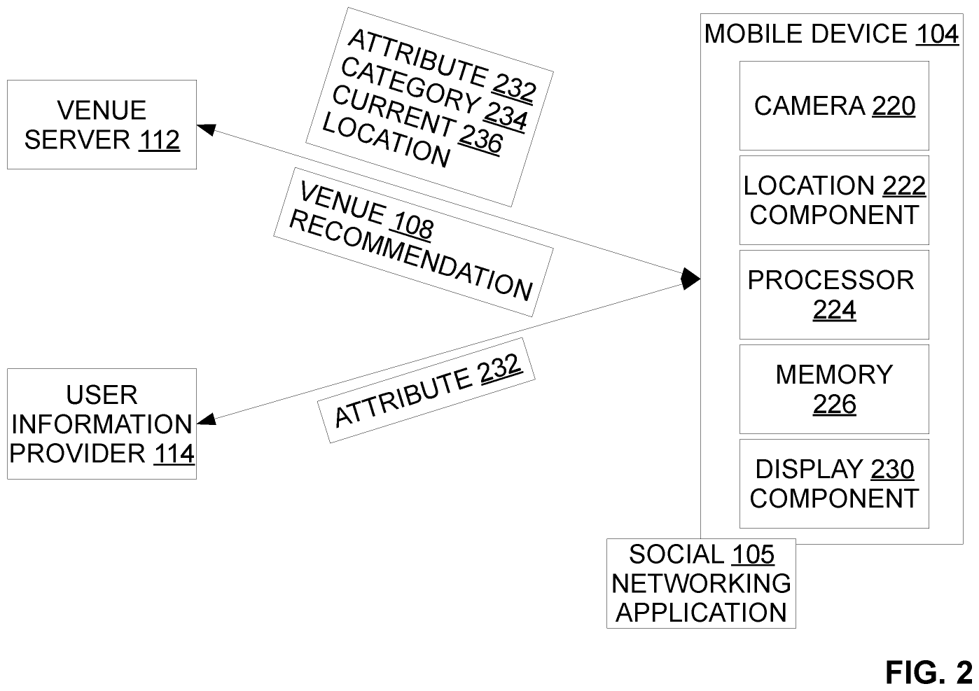

FIG. 2 shows a display diagram illustrating interactions between components of a system that provides a location based venue recommendation. In an example scenario, the mobile device 104 may include components such as a camera 220, a location component 222, a processor 224, a memory 226, and a display component 230. The processor 224 may execute instructions associated with the social networking application 105. The memory 226 may store and provide the instructions to the processor 224 for execution. The display component 230 may include a screen, and/or a monitor, among others that provide an input and an output associated with the social networking application 105 to the user.

In an example scenario, the user (such as a member of a social network) may desire to go to a venue. The venue may include a restaurant, a café, a bar, a market, a bakery, a park, and/or a retail store, among others. The social networking application 105 may help the user to choose the venue based a number of parameters associated with the user. For example, the social networking application 105 may gather parameters such as an attribute 232 of the user, a category 234, and a location 236 (such as a current or a destination location) to determine a matching venue (or venues). The matching venue may be presented to the user within the venue recommendation 108.

The social networking application 105 may use data gathering and analysis capability associated with a social network to locate and provide the venue recommendation 108. For example, the user may have the attribute 232 including a disability, an eating disorder, a language preference, a noise sensitivity, a light sensitivity, a need, a demand, and/or a preference. The attribute 232 associated with the user may be stored and provided by the user information provider 114. The user information provider 114 may include a user information service hosted in a local or remote server, server cluster, and/or cloud based computing system, among others.

The social networking application 105 may query the user information provider 114 to retrieve the attribute 232. Alternatively, the attribute 232 may be stored and retrieved from a local resource of the mobile device 104 that hosts a user profile associated with the user.

The social networking application 105 may also determine other parameters associated with a venue search. By default, the mobile device 104 may query a location component 222 to determine a current location as the location 236. The location component 222 may include sensor(s) that may capture the location 236 from a GPS/GLONASS/Galileo signal or by radio signal triangulation of the location 236 from other radio signal sources such as cell tower(s) and/or wireless signal sources, among others. Furthermore, the location 236 may be determined from a previous location based on a direction, a route, and/or a distance traveled from the previous location. The current location may be used to center a venue search within a surrounding area. The surrounding area may encompass locations within a proximity to the current (or destination) location. Dimensions of the surrounding area may be automatically determined based on number of factors such as the user's mobility or manually provided by the user. Alternatively, the social networking application 105 may accept a location input from the user such as a destination location to use as an anchor in a search for the venue within the surrounding area.

Moreover, the social networking application 105 may receive another input selecting the category 234 from provided category options. A category (or a classification of a venue) provided as a selection option may include a food category, a travel category, a parks category, a desert category, an entertainment category, an others category, and/or similar ones. The others category may be a custom category that may be editable by the user (or other social network member).

The attribute 232, the category 234, and/or the location 236 may be sent to a venue server 112 to prompt the venue server 112 to search for a venue that accommodates the provided parameters. For example, the venue server 112 may search for the venue(s) that are within the surrounding area centered around the location 236. The surrounding area may include a circular region centered around the location 236. A radius of the surrounding area may be automatically determined based on the attribute or other parameters associated with the user. For example, if the user is detected as travelling over a certain speed threshold (such as faster than a walking speed) then the user may be determined to be travelling in a vehicle. In such a scenario, the radius may be expanded to encompass a larger surrounding area in which to search the venue. Alternatively, if the user is determined to travel at a walking speed, then the radius may be shrunk to encompass a smaller surrounding area in which to search the venue. In another example scenario, the user may be allowed to set the radius centered on the location 236.

Alternatively, the user may select the destination location as a parameter for the venue search. The destination location may also be automatically predicted from presence information associated with the user such as a previous destination, a frequency of presence at the previous destination, and/or a direction and a speed of travel, among others.

The venue server 112 may be a component of a social networking system providing a social network service. Alternatively, the venue server 112 may include a vendor based system that hosts information associated with retail vendor(s). The venue server 112 may receive the search parameters such as the attribute 232, the category 234,and the location 236 and conduct a search to locate a venue that accommodates the provided parameters. In an example scenario, the venue server 112 may locate a venue that is within a surrounding area of the location 236, is classified with the category 234, and includes a feature that accommodates the attribute 232. For example, a distance of the venue to the location 236 (the current or destination location) may be under 1 kilometer, as such qualified as within a surrounding area (or walking distance) of the location 236.

Upon locating the venue that accommodates the provided parameters, the venue server may retrieve the venue recommendation 108 that includes information associated with the venue. The venue recommendation 108 may be sent to the social networking application 105. The social networking application 105 may display the venue recommendation 108 to the user and provide additional functionality associated with the venue. For example, the social networking application 105 may provide controls to allow the user to navigate to the venue. The controls may also allow the user to capture a picture associated with the venue through a camera 220. The picture may be used to edit (such as a review) and update the venue recommendation 108 which may be uploaded to the venue server 112 for further dispersal to other members of the social network. Furthermore, the user may also be allowed to capture a video stream associated with the venue through the camera 220. The length of the video stream may be limited by a default (or configurable) duration. The video stream may be used to edit (such as a review) and update the venue recommendation 108.

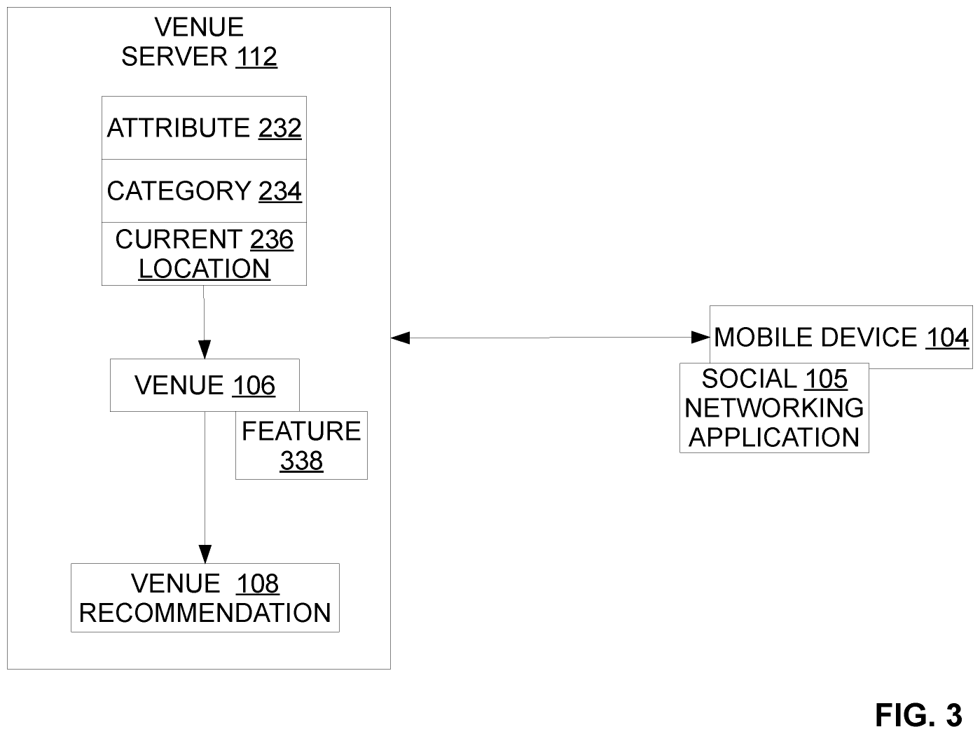

FIG. 3 shows a display diagram illustrating a mechanism of providing a location based venue recommendation. The social networking application 105 (executed by the mobile device 104) may query the venue server 112 for the venue recommendation 108. The query may include the attribute 232 of the user, the category 234 (of the venue), and the location 236 (the current or destination location). In response, the venue server 112 may search a database that includes number of venues and associated venue recommendations to locate the venue 106 that includes a feature 338. The feature 338 may accommodate the attribute 232 of the user.

For example, the attribute 232 of the user may include a disability that limits mobility. The venue server 112 may locate the venue 106 that includes mobility aides (or excludes restricted mobility) as the feature 338. In another scenario, the attribute 232 of the user may include an eating disorder such as celiac disease (or an eating preference such as veganism). The venue server 112 may locate the venue 106 that includes gluten free food (or vegan food for the eating preference) as the feature 338. In another example scenario, the attribute 232 may include a language preference such as a Spanish based service. The venue server 112 may locate the venue 106 that include the Spanish based service as the feature 338.

Alternatively, the attribute 232 of the user may encompass another attribute of a person within a group associated with the user. For example, the user is determined to be situated or traveling with the group to the location 236 (or the destination location). The group may include a family, co-workers, acquaintances, friends, and/or non-related people among others. In an example scenario, the group may include children (or elderly). The social networking application 105 may use the age of the acquaintance within the group as the attribute 232. As such, the venue server 112 may locate the venue 106 that includes the feature 338 accommodating the age of the acquaintance in the group. For example, the user may travel with a child. The venue server 112 may locate the venue 106 that includes the feature 338 (such as a playground, a high chair, and/or a changing station, among others) accommodating the child.

The venue server 112 may next send the venue recommendation 108 to the social networking application 105. The social networking application 105 may display the venue recommendation 108 to the user. Alternatively, the social networking application 105 may conduct the venue search locally. The social networking application 105 may access a database associated with the venue 106, conduct a search, and locate the venue 106 using local resources. In an example scenario, the mobile device 104 may host a database associated with the venue 106. Alternatively, the social networking application 105 may access a remote venue database to conduct the venue search. However, the social networking application 105 may use local processing resources to conduct the venue search.

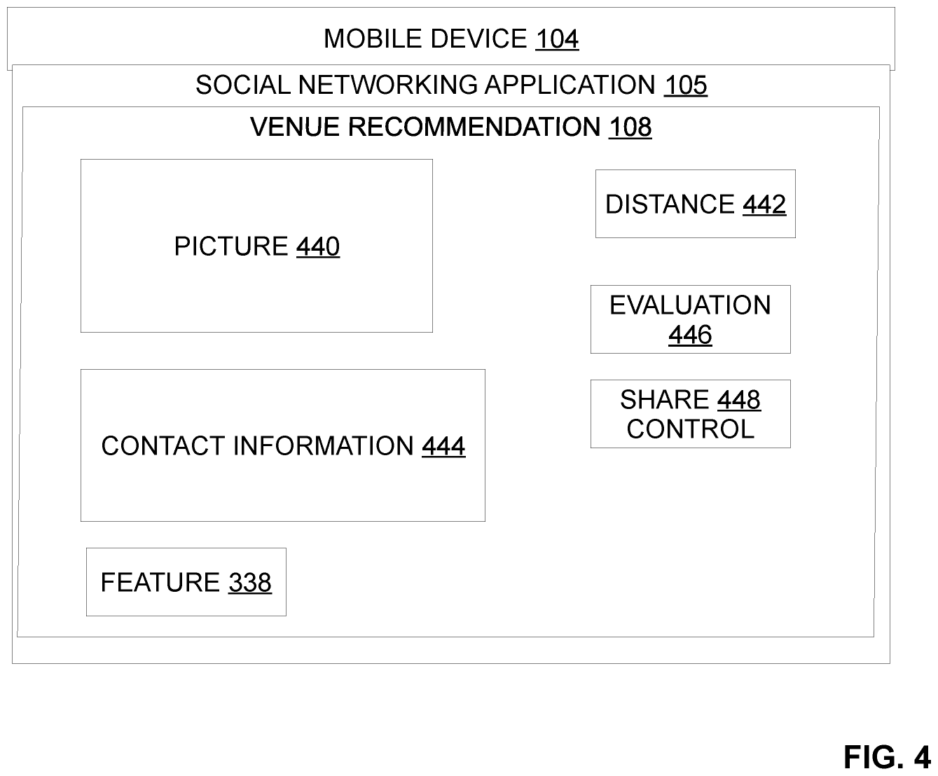

FIG. 4 shows a display diagram illustrating an example of a user experience providing a location based venue recommendation. In an example scenario, the social networking application 105 (executed by the mobile device 104) may display the venue recommendation. The venue recommendation may include a picture 440 of the venue, a distance 442 to the venue from the current or destination location, an address of the venue, a contact information 444 associated with the venue, the feature 338 provided by the venue, and/or an evaluation 446 associated with the venue.

The feature 338 may include physical aspects and/or services provided by the menu that accommodate the attribute of the user. The evaluation 446 may include controls to evaluate the venue with a rating system (such as a number based or a binary mechanism). The distance 442 may include controls to launch a navigation section that displays a route (and navigation instructions) to the venue from the selected location (the current or destination location). Furthermore, the venue recommendation 108 may include a share control 448. The share control 448 may include operations to share the venue recommendation 108 with others such as members of the social network using a variety of modalities such as email, and/or text messaging, among others.

The venue recommendation 108 may also include an identifier of a creator or a modifier, a time of publishing, a number of approvals and/or disapprovals, a comment, and/or a label. The number of the approvals and/or disapprovals may reflect results a binary evaluation scheme used to collect data on the venue recommendation 108 from members of the social network. The comment may be provided by the user or member(s) of the social network. The label may include an annotation and/or a classification applied to the venue recommendation 108 by the user or the member(s) of the social network.

Furthermore, editable and/or updateable elements of the venue recommendation 108 may be subject to data integrity screening and monitoring that may initiate further actions associated with the monitored element. For example, an indecent comment may trigger an action to remove the comment and ban the author of the comment from commenting on the venue recommendation or other activities. A low ranking associated with the venue may trigger an action to warn the user to avoid the venue, among others.

In another example scenario, the social networking application 105 may transmit a notification to the user when a current location of the user is matched to a venue location. The notification may describe and alert the user regarding arrival at the venue location.

In yet another example scenario, the social networking application 105 may receive the picture 440 from a camera component of the mobile device 104 at the venue location. The social networking application 105 may process the picture with a local image recognition resource or a remote image recognition provider. The picture 440 may be processed to recognize an object associated with the feature 338 provided by the venue. For example, the object may include a ramp recognized as the feature provided by the venue that accommodates the attribute of the user which includes a disability associated with mobility.

The social networking application 105 may detect the object within the processed picture 440. The object may be highlighted within the picture as evidence of the feature 338. For example, the object may be encompassed with a colored edge, a shading may be applied to the object, and/or similar ones. The picture 440 may also be automatically labeled or categorized to refer to the feature 338 (such as with the name of the object accommodating the feature 338). The picture 440 may next be integrated with the venue recommendation 108.

Alternatively, the external image recognition provider may process the picture 440, highlight the object within the picture 440, label/categorize the picture 440 and, provide the processed picture 440 to the social networking application 105. The social networking application 105 may integrate the picture 440 into the venue recommendation 108.

In an alternative scenario, the social networking application may fail to detect the object within the picture 440. As a result, the social networking application 105 may automatically classify the venue recommendation 108 with a suspicious status in relation to the feature 338 (provided by the venue). In some scenarios, an automated verification process may initiate an action to remove the venue recommendation 108 upon one or more failures to detect the object (associated with the feature 338) in the picture 440 (or other picture(s) provided by other member(s) of the social network).

The example scenarios and schemas in FIGS. 1 through 4 are shown with specific components, data types, and configurations. Embodiments are not limited to systems according to these example configurations. A location based venue recommendation may be implemented in configurations employing fewer or additional components in applications and user interfaces. Furthermore, the example schema and components shown in FIGS. 1 through 4 and their subcomponents may be implemented in a similar manner with other values using the principles described herein.

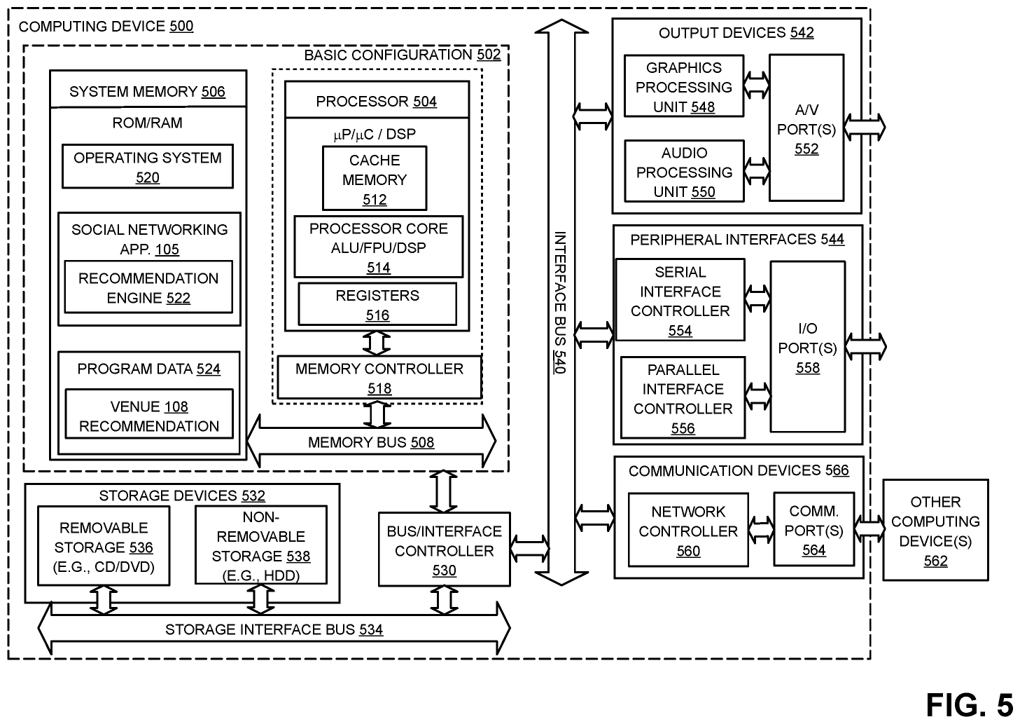

FIG. 5 is a block diagram of an example computing device, which may be used to provide a location based venue recommendation, according to embodiments.

For example, computing device 500 may be used as a server, desktop computer, portable computer, smart phone, special purpose computer, or similar device. In a basic configuration 502, the computing device 500 may include one or more processors 504 and a system memory 506. A memory bus 508 may be used for communication between the processor 504 and the system memory 506. The basic configuration 502 may be illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, one or more processor cores 514, and registers 516. The example processor cores 514 may (each) include an arithmetic logic unit (ALU), a floating-point unit (FPU), a digital signal processing core (DSP Core), a graphics processing unit (GPU), or any combination thereof. An example memory controller 518 may also be used with the processor 504, or in some implementations, the memory controller 518 may be an internal part of the processor 504.

Depending on the desired configuration, the system memory 506 may be of any type including but not limited to volatile memory (such as RAM), non-volatile memory (such as ROM, flash memory, etc.), or any combination thereof. The system memory 506 may include an operating system 520, the social networking application 105, and a program data 524. The social networking application 105 may include components such as a recommendation engine 522. The recommendation engine 522 may execute the instructions and processes associated with the social networking application 105. In an example scenario, the recommendation engine 522 may receive an initial input from a user. The initial input may include a selected location. A subsequent input may also be received from the user. The subsequent input may include a selected category. An attribute of the user may further be determined. Next, a venue server may be queried with the selected location, the selected category, and the attribute of the user. A venue recommendation may be received in response to the query. The venue may be in proximity to the selected location, may be within the selected category, and a feature of the venue may accommodate the attribute of the user. Furthermore, the venue recommendation may be displayed to the user.

Input to and output out of the social networking application 522 may be captured and displayed through the display component 230 (as shown in FIG. 2) that may be integrated to the computing device 500. The display component 230 (as show in FIG. 2) may include a display screen, and/or a display monitor, among others that may capture an input through a touch/gesture based component such as a digitizer. The program data 524 may also include, among other data, the venue recommendation 108, or the like, as described herein. The venue recommendation 108 may include a picture, a contact information, a distance, an evaluation, a share option, and/or a feature associated with the venue, among other things.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and one or more communication devices 566) to the basic configuration 502 via the bus/interface controller 530. Some of the example output devices 542 include a graphics processing unit 548 and an audio processing unit 550, which may be configured to communicate to various external devices such as a display or speakers via one or more A/V ports 552. One or more example peripheral interfaces 544 may include a serial interface controller 554 or a parallel interface controller 556, which may be configured to communicate with external devices such as input devices (for example, keyboard, mouse, pen, voice input device, touch input device, etc.) or other peripheral devices (for example, printer, scanner, etc.) via one or more I/O ports 558. An example of the communication device(s) 566 includes a network controller 560, which may be arranged to facilitate communications with one or more other computing devices 562 over a network communication link via one or more communication ports 564. The one or more other computing devices 562 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a specialized server, mainframe, or similar computer, which includes any of the above functions. The computing device 500 may also be implemented as a personal computer including both laptop computer and non-laptop computer configurations. Additionally, the computing device 500 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to provide a location based venue recommendation. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

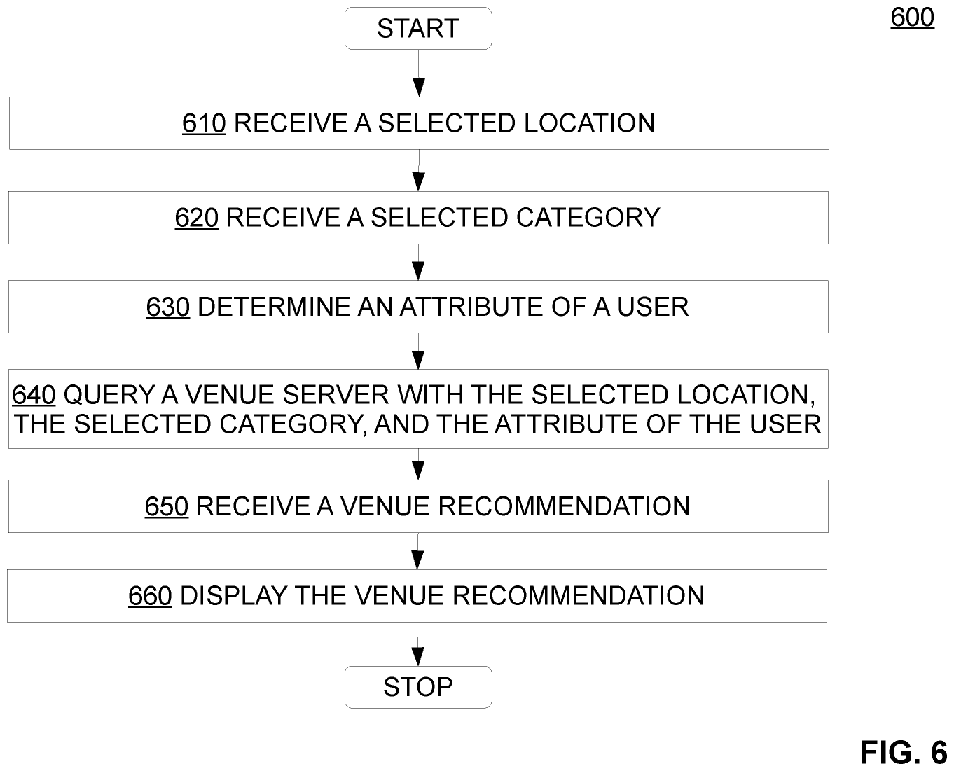

FIG. 6 is a logic flow diagram illustrating a process for providing a location based venue recommendation. Process 600 may be implemented on a computing device, such as the computing device 500 or another system.

Process 600 begins with operation 610, where a social networking application may receive a selection of a location from a user. The selected location may include a current location of the user or a destination location to which the user may desire to travel. Next, at operation 620, a selection of a category may be received from the user. The selected category may include a food category, a travel category, a parks category, a desert category, an entertainment category, and/or an others category, among others. At operation 630, an attribute of the user may further be determined. The attribute of the user may include a disability, an eating disorder, a language preference, a noise sensitivity, a light sensitivity, a need, and/or a demand. Furthermore, the attribute may include an attribute of an entity (such as a child) situated or travelling with the user.

Next, at operation 640, a venue server may be queried with the selected location, the selected category, and the attribute of the user. At operation 650, a venue recommendation may be received in response to the query. The venue may be in proximity to the selected location, may be within the selected category, and a feature of the venue may accommodate the attribute of the user. At operation 660, the venue recommendation may be displayed to the user.

The operations included in process 600 is for illustration purposes. A location based venue recommendation may be implemented by similar processes with fewer or additional steps, as well as in different order of operations using the principles described herein. The operations described herein may be executed by one or more processors operated on one or more computing devices, one or more processor cores, specialized processing devices, and/or special purpose processors, among other examples.

A method of providing a location based venue recommendation is also described. The method may include receiving a destination location provided by a user. A selected category provided by the user may also be received. An attribute of the user may be queried and received from an external user information provider. Next, a venue recommendation may be queried and received from a venue provider. A venue associated with the venue recommendation may be in a proximity to the destination location, may be within the selected category, and a feature of the venue may accommodate the attribute of the user. The venue recommendation may also be displayed to the user on the display component. The proximity of the destination location may include a surrounding area centered around the destination location.

Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory. Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following:

a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface.

Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution

(LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/mylnformation.html” portion of the request and resolve it to a location in memory containing the information “mylnformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like. A beverages table including, for example, heat capacities and other useful parameters of different beverages, such as depending on size beverage_name, beverage_size, desired_coolingtemp, cooling_time, favorite_drinker, number_of beverages, current_beverage_temperature, current ambient_temperature, and/or the like. A Parameter table may include fields including the foregoing fields, or additional ones such as cool start_time, cool_preset, cooling_rate, and/or the like. A Cool Routines table may include a plurality of cooling sequences may include fields such as, but not limited to: sequence_type, sequence_id, flow_rate, avg_water_temp, cooling_time, pump_setting, pump_speed, pump_pressure, power_level, temperature sensor_id_number, temperature sensor_location, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system for providing a location based venue recommendation, the system comprising:
a venue server, wherein the venue server is configured provide the venue recommendation;
a mobile device configured to:
receive an initial input from a user, wherein the initial input includes a selected location;
receive a subsequent input from the user, wherein the subsequent input include a selected category;
determine an attribute of the user;
query the venue server with the selected location, the selected category, and the attribute of the user;
receive the venue recommendation from the venue server, wherein a venue associated with the venue recommendation is in a proximity to the selected location, is within the selected category, and a feature of the venue accommodates the attribute of the user; and
display the venue recommendation to the user.

2. The system of claim 1, wherein the selected location includes a current location of the user or a destination location provided by the user.

3. The system of claim 1, wherein the proximity to the selected location encompasses a surrounding area.

4. The system of claim 3, wherein the surrounding area includes a circular region centered around the selected location.

5. The system of claim 1, wherein receiving the subsequent input further includes one or more operations to:
display categories to the user, wherein the categories include one or more of a food category, a travel category, a parks category, a desert category, an entertainment category, and an others category; and
detect a selection of one or more of the categories as the subsequent input.

6. The system of claim 1, wherein the attribute of the user is provided by the user.

7. The system of claim 1, wherein the attribute of the user is retrieved from a profile of the user stored locally or remotely.

8. The system of claim 1, wherein the attribute of the user includes one or more of a disability, an eating disorder, a language preference, a noise sensitivity, a light sensitivity, a need, and a demand.

9. The system of claim 1, wherein the attribute of the user further encompasses another attribute of a person within a group associated with the user, and wherein the group is determined to be situated at or travel to the selected location.

10. The system of claim 1, wherein the venue includes a restaurant, a café, a bar, a market, a bakery, a park, or a retail store.

11. The system of claim 1, wherein the venue recommendation includes one or more of
a picture of the venue,
a distance to the venue from the selected location,
an address of the venue,
a contact information associated with the venue,
the feature provided by the venue, and
an evaluation associated with the venue.

12. The system of claim 1, wherein the venue recommendation includes
an identifier associated with a creator or a modifier,
a time of publishing,
a number of approvals or disapprovals,
a comment,
a label, and
an option to share.

13. A mobile device for providing a location based venue recommendation, the mobile device comprising:
a display component configured to accept an input and display an output associated with a social networking application,
a camera component configured to capture a picture in relation to the social networking application,
a location component configured to determine a current location in an association with the social networking application,
a memory configured to store instructions associated with the social networking application,
a processor coupled to the display component, the location provider, the camera component, and the memory, the processor executing the instructions associated with the social networking application, wherein the social networking application includes:
a recommendation engine configured to:
receive a current location from the location component;
receive a selected category provided by a user as an input on the display component;
query and receive an attribute of the user from an external user information provider;
query and receive the venue recommendation from a venue provider, wherein a venue associated with the venue recommendation is in a proximity to the current location, is within the selected category, and a feature of the venue accommodates the attribute of the user; and
provide the venue recommendation to the display component for a presentation to the user.

14. The mobile device claim 13, wherein the location component is configured to determine the current location from one or more of:
a global positioning system (GPS) signal, a GLONASS signal, or a Galileo signal;
a radio signal triangulation mechanism; and
a previous location based on a direction and a distance traveled from the previous location.

15. The mobile device of claim 13, wherein the recommendation engine is further configured to:
determine an update to the current location from the location provider;
match the updated current location to a venue location; and
display a notification to the user, wherein the notification describes the user at the venue location.

16. The mobile device of claim 15, wherein the recommendation engine is further configured to:
receive a picture from the camera component; and
process the picture to recognize an object associated with the feature provided by the venue.

17. The mobile device of claim 16, wherein the recommendation engine is further configured to:
detect the object within the picture;
highlight the object within the picture as an evidence of the feature;
label or categorize the picture to refer to the feature; and
integrate the picture with the venue recommendation.

18. The mobile device of claim 16, wherein the recommendation engine is further configured to:
fail to detect the object within the picture; and
classify the venue recommendation with a suspicious status in relation to the feature provided by the venue.

19. A method of providing a location based venue recommendation, the method comprising:
receiving a destination location provided by a user;
receiving a selected category provided by the user;
querying and receiving an attribute of the user from an external user information provider;
querying and receiving a venue recommendation from a venue provider, wherein a venue associated with the venue recommendation is in a proximity to the destination location, is within the selected category, and a feature of the venue accommodates the attribute of the user; and
displaying the recommendation of the venue to the user.

20. The method of claim 19, wherein the proximity to the destination location includes a surrounding area centered on the destination location.
